(19) United States
(12) Patent Application Publication
(10) Pub. No.: US 2006/0150459 A1
(43) Pub. Date: Jul. 13, 2006

(54) Combination of articles using a multi-function tag

(76) Inventor: Jessie Li-kuo Wang, Fremont, CA (US)

Correspondence Address: Jessie Li-Kuo Wang, 46980 Ocotillo Ct., Fremont, CA, 94539, US

(21) Appl. No.: 11/033,078

(22) Filed: Jan. 10, 2005

(51) Int. Cl. G09F 3/08

(52) U.S. Cl. 40/663

(57) ABSTRACT

The present invention comprises a combination of articles of manufacture where the articles are combined using a multi-function tag. The first article of manufacture that is combined is the tag itself. The tag has a tag body, an information housing portion attached to the tag body, and a frictional fastener attached to the tag body. The frictional fastener has an elongated shape and has ridges disposed substantially perpendicular to the longitudinal dimension of the elongated shape. The tag body has an aperture, and the tag has a string fastener that passes through the body aperture to form an attachment between the string and the tag. The second article that is combined has a frictional fastener receiving portion. This second article is attached to the tag by a union of the frictional fastener and the frictional fastener receiving portion and held in place by the ridges,of the frictional fastener. The third article has a string fastener receiving portion. The third article is attached to the tag by a union of the string fastener and the string fastener receiving portion. In this manner, all three articles of manufacture are mutually combined to form a unit.

### FIELD OF THE INVENTION

This invention relates to information containing tags for articles of manufacture. Such information may be price information, information as to identity of the manufacturer, distributor, or retailer of the article of manufacture, and so forth.

### BACKGROUND OF THE INVENTION

The present invention relates to articles of manufacture that incorporate tags having information on the tags. Such information may be price information, information as to identity of the manufacturer, distributor, or retailer of the article of manufacture, and so forth. Examples of tags in the prior art are adhesive labels that are applied directly to the article of manufacture, as well as labels that are attached by means of a string.

### SUMMARY OF THE INVENTION

The present invention comprises a combination of articles of manufacture where the articles are combined using a multi-function tag. The first article of manufacture that is combined is the tag itself. The tag has a tag body, an information housing portion attached to the tag body, and a frictional fastener attached to the tag body. The frictional fastener has an elongated shape and has ridges disposed substantially perpendicular to the longitudinal dimension of the elongated shape. The tag body has an aperture, and the tag has a string fastener that passes through the body aperture to form an attachment between the string and the tag. The second article that is combined has a frictional fastener receiving portion. This second article is attached to the tag by a union of the frictional fastener and the frictional fastener receiving portion and held in place by the ridges of the frictional fastener. The third article has a string fastener receiving portion. The third article is attached to the tag by a union of the string fastener and the string fastener receiving portion. In this manner, all three articles of manufacture are mutually combined to form a unit.

### BRIEF DESCRIPTION OF THE DRAWINGS

FIG. 1 illustrates a combination of articles in accordance with the present invention.

FIGS. 2A and 2B illustrate two multi-function tag embodiments of the present invention which feature apertures in the tag body to retain string fasteners.

FIGS. 3A and 3B illustrate two multi-function tag embodiments of the present invention which feature a string fastener directly attached to the tag body in the case of FIG. 3A and a string fastener that is integral to the tag body in the case of FIG. 3B.

FIGS. 4A to 4D feature multi-function tag embodiments of the present invention that are of a “flag” type construction.

FIG. 5 illustrates a combination in accordance with the present invention.

FIG. 6 illustrates another combination in accordance with the present invention.

FIG. 7 illustrates another combination in accordance with the present invention.

### DETAILED DESCRIPTION OF THE PREFERRED EMBODIMENTS

The various figures illustrate various preferred embodiments of the present invention.

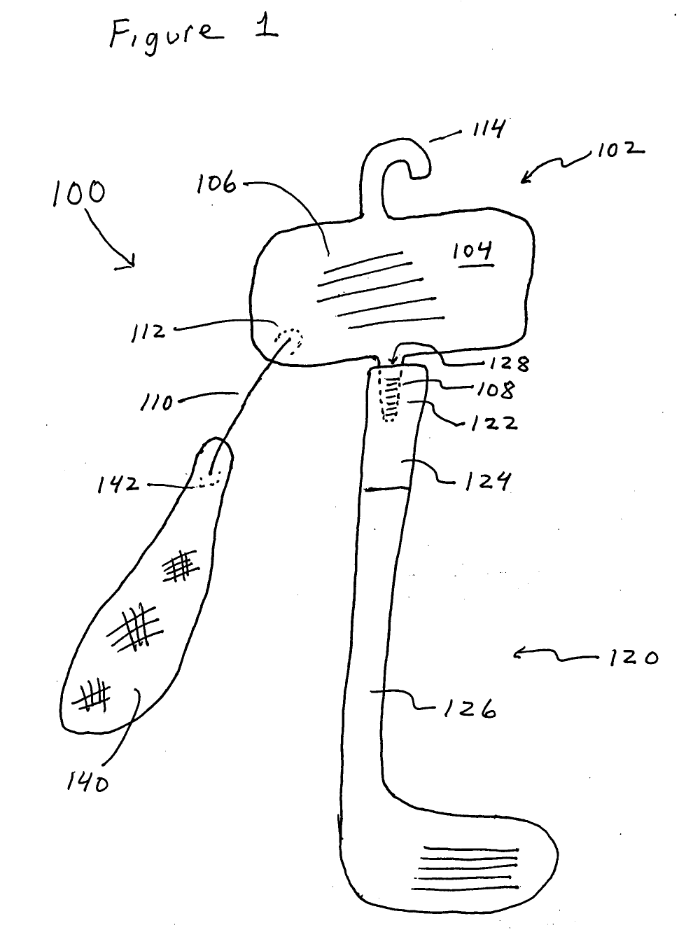

FIG. 1 illustrates one embodiment of the present invention. A preferred invention is a combination of articles of manufacture. FIG. 1 illustrates an example of such a combination 100. The example combination 100 includes a first article 102 which is also referred to as “tag 102”, a second article 120 which for some embodiments is also referred to as “golf club 120”, and a third article 140 which for some embodiments is also referred to as “head cover 140.” It can be observed that golf club 120 and head cover 140 are complementary articles which may be sold as a unit. That is, golf club 120 and head cover 140 may be sold together as part of combination 100 as a unit for a single price. For example, $37.95 could be the cost of combination 100. A head cover 140 is used to cover the head of golf club 120 to protect the head from accidental denting, scratching, wear, or other damage.

In the present invention of combination 100, tag 102 has tag body 104, an information housing portion 106 attached to tag body 104, a male threaded screw fastener 108 attached to tag body 104, and a string fastener 110 attached to tag body 104 at string-tag union portion 112. Hanger 114 is attached to tag body 104 to provide a means for hanging combination 100. In this embodiment, hangar 114 is illustrated as a hook.

Combination 100 has second article 120, which in this embodiment is golf club 120 having a screw receiving portion 122. Screw receiving portion 122 is a region within golf club 120 to which tag 102 may be attached by placing screw fastener 108 into screw receiving portion 122. It can be observed that golf club 120 has a grip portion 124 at an end of shaft 126. Screw receiving portion 122 is a region within grip portion 124. Grip portion 124 comprises rubber or a rubber-like substance for its surface and for screw receiving portion 122. Thus, second article 120 is attached to tag 102 by a union of screw fastener 108 and the screw receiving portion 122. Screw receiving portion 122 may have screw receiving aperture 128 which is an aperture within grip portion 124. As illustrated in FIG. 1, screw receiving aperture 128 is disposed concentrically along the longitudinal axis of shaft 126. Screw fastener 108 may be provided in relatively rigid plastic or other relatively rigid material (including metal) and thereby provide a relatively rigid attachment of tag body 104 to second article 120. Screw fastener 108, and its concentric grooved and ridge counterpart that is mentioned elsewhere in this disclosure function by means of friction. In other words, they are frictional fasteners and it is a friction mechanism that retains screw fastener in place in screw receiving portion 122.

In this embodiment, there is third article 140 which is head cover 140. Head cover 140 has a string fastener receiving portion 142. Head cover 140 is attached to tag 102 by a union of string fastener 110 and string fastener receiving portion 142. Head cover 140 is also attached to golf club 120, and golf club 120 is attached to head cover 140, by way of tag 102. It can be seen that Tag 102, golf club 120, and head cover 140 are all mutually attached parts of combination 100. That is, tag 102, golf club 120, and head cover 140 are all attached to each other, either by way of direct attachment in the case of the tag 102 to golf club 120 attachment by way of the union of screw fastener 108 with screw receiving portion 122, direct attachment in the case of tag 102 to head cover 140 by way of string fastener 110 which joins to string-tag union portion 112 of tag 102 and to string fastener receiving portion 142 of head cover 140. In one embodiment, string-tag union portion 112 is an aperture within tag body 104 of tag 102. In this embodiment, a portion of string fastener 116 is disposed within the aperture and the material of tag body 104 that surrounds the aperture presents a barrier to the separation of string fastener 116 from tag body 104, with further details of this barrier described below.

In another embodiment, the combination 100 comprises tag 102, second article 120 and third article 140. In this embodiment, second article 120 is an article of manufacture that is not necessarily a golf club. In this embodiment, third article is an article of manufacture that is not necessarily a head cover. In an example of this embodiment, second article 120 is a beach umbrella third article 140 is a beach towel.

Information housing portion 106 may be a substantially planar surface. Information housing portion 106 provides information about the combination of articles and may display human readable information, such as written words or symbols on such a substantially planar surface. Examples of such information are product name, product part number, product size, price, manufacturer's name, manufacturer or distributor's trademark, and so forth. Information housing portion 106 may have human readable information directly printed onto information housing portion. For example, information housing portion may be a flat area made of plastic and information may be printed onto that area using ink or paint. Alternatively, human readable information may be molded into, or stamped into information housing portion 106. An adhesive label having human readable information may be placed onto and adhered to a substantially planar surface of information housing portion 106.

Either alternatively to human readable information, or in addition to human readable information, a radio frequency identification tag may be placed within or attached to information housing portion 106. Radio frequency identification tags are tags that have electronic information within them and these tags use radio frequency transmissions to transmit the information to receivers that are within range of the transmission. These tags are responsive to radio frequency fields and they transmit when such a field is used to induce such a transmission.

It can be seen that the various embodiments of the present invention feature a multi-function tag 102. The tag functions to join complementary articles of manufacture, one article by means of a screw fastener 108, another article by means of a string fastener 110. The multi-function tag 102 provides an information housing portion 106 in order to not only combine the articles but also to provide information about the combination.

It should be understood that in the drawings the articles that are combined are not drawn to scale. For example, the tag 102 and the golf club 120 are not drawn in proportion to each other but are drawn in a way to conveniently show the relationship of and the manner of combining the articles that comprise the combination of the present invention.

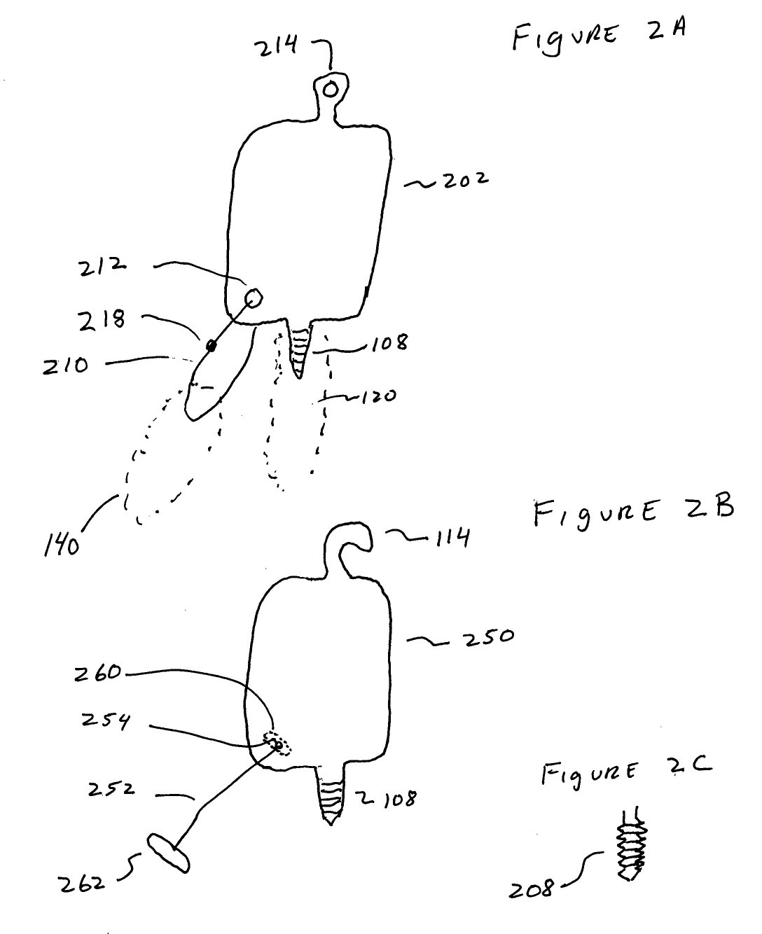

FIG. 2A illustrates a multi-function tag embodiment of the invention in connection with tag 202 in that string fastener 210 may be provided as a loop through aperture 212. Portions of second article 120 and third article 140 are indicated by dashed lines. The loop of string fastener 210 may be provided by a variety of means. One means of providing a loop is to first pass string fastener 210 through aperture 212 and then create joint 218 which may be a weld or a knot such that an “O” shaped loop passes through aperture 212. An alternative approach would be to create an “O” loop in string fastener 210 and pass the loop of string fastener 210 through aperture 212 then drawing a portion of the “O” loop through another portion of the “O” loop to create a fastening to tag 202. This later method is similar to the method by which rubber bands are jointed together using what is commonly referred to as a “cow hitch” know. It should be noted that in this embodiment hangar 214 is provided as an aperture which is an alternative to a hook-type embodiment.

FIG. 2B illustrates a “barb” method of providing the attachment between the third article 140 and tag 250. In this embodiment string fastener 252 passes through aperture 254 within tag 250. In this embodiment barb 260 and barb 262 are provided at opposite ends of string fastener 252. Barb 260 does not easily pass through aperture 254 since aperture 254 is large enough to permit barb 260 or barb 262 to pass through aperture 254 but aperture 254 is sufficiently small as to prevent barb 260 or barb 262 from making a return passage back through aperture 254. The barb 260 or barb 262 thus serves as a retainer to retain string fastener within tag 250 and third article 140. In the normal course, some human intervention must occur in order to manipulate barb 260 to a particular angle such that the barb can pass through aperture 254. Barb 260 and barb 262 as well as aperture 254 may be provided with relative sizes (large barb, small aperture) such that the only means of withdrawing string fastener 252 from tag 250 is by forcibly breaking string fastener 352. In this embodiment, third article 140 is not shown but it is understood to be fastened to string fastener 252 with either barb 260 or 262 passing through third article 140 to retain third article 140 to string fastener 252.

In one embodiment illustrated by FIG. 2C, screw fastener 208 is not a threaded screw in the sense that threaded make screws have a single ridge and a single groove that wind around an axis in a spiral fashion but instead screw fastener 208 features a number of concentric circular grooves and ridges. It can be understood that in the case of a threaded screw tag 202 may be attached to second article 120 by screwing tag 202 into second article 120. In other words, the attachment may be made through a relative rotational movement of tag 202 onto second article 120. An advantage of a screw fastener is that the screw may be self-taping, that is, the screw can force its way into screw receiving region 122 provided that the material of screw receiving region 122 is sufficiently conforming to screw fastener 208, in other words, soft rubber or the like. Alternatively, screw receiving region 122 may be provided with female threads adapted to conform to screw fastener 308. In a reverse fashion to the manner of attachment, tag 202 may be removed from second article 120 through reverse rotation of the respective articles.

In the case of a concentric grooves and ridges of screw fastener 208, screw fastener 208 is forcibly inserted into screw receiving region 122, rather than screwed into screw receiving region 122. In this case, there is no true “screw” for the screw fastener 208 but a fastener having a general appearance of a male threaded screw.

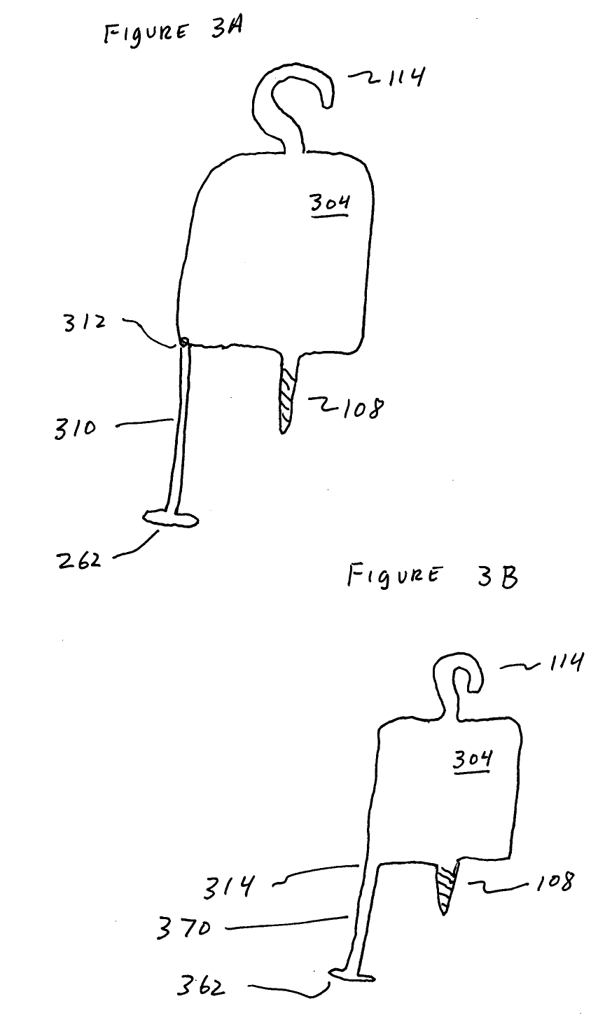

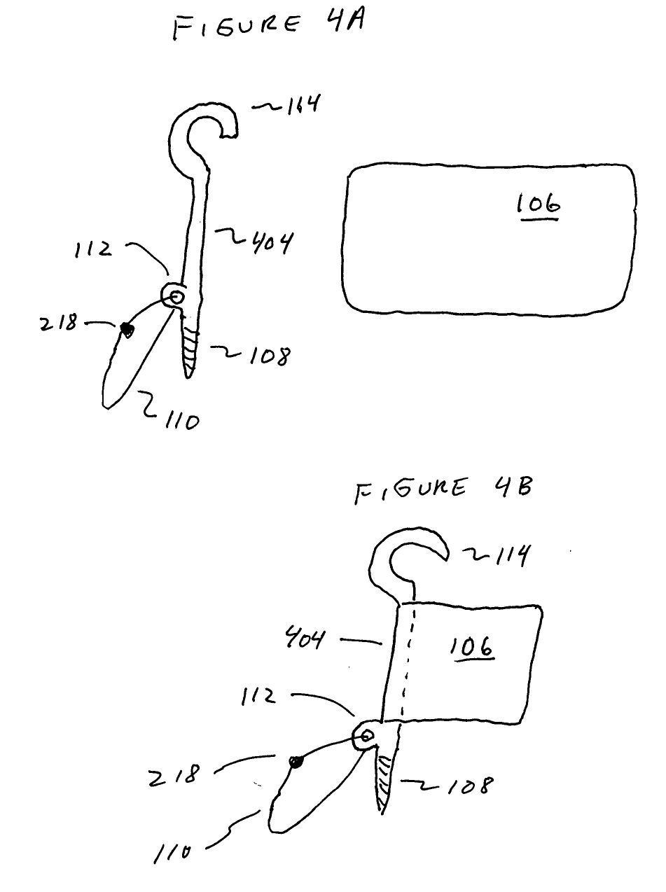

Now turning to FIGS. 3A, tag body 304 and string fastener 310 may be directly attached to be joined at joint 312 by a variety of means. In this embodiment, string fastener 310 may be cemented, or otherwise glued to tag body 304 at joint 312. Similarly, string fastener 310 may be of a similar material to tag body 304 and welded to tag body 304.

It should be understood that in the variety of embodiments of this invention string fastener 310 and its counterparts in other embodiments can be selected from a variety of materials. In fact, the “string” aspect of “string fastener” refers to form and function rather than particular material. For example, string fastener 310 may be a single nylon strand (monofilament) or it may be multi-stranded fiber. String fastener 110, 210, 310, and so forth may also be made of metal, as by copper or steel wire.

In the embodiment of FIG. 3B, however, and 3B, tag body 304 and string fastener 370 are comprised of an integral homogeneous material. In the embodiment of FIG. 3B, string fastener 370 and tag body 304 are comprised of a homogeneous material. One method of forming the combination of tag body 304 and string fastener 370 is to mold tag body 304, barb 262, and string fastener 370 in a single manufacturing step. In this embodiment, it may be advantageous use nylon or some other plastic as the homogeneous material and make the molded combination while drawing barb 362 away from tag body 304 while string fastener is at an elevated temperature to create an elongated string fastener. In this manner, string fastener is molded into a strand that may be somewhat thicker than it will be for the completed tag-string homogeneous article and through drawing the barb 362 away from tag 304 while still string fastener 370 is at an elevated temperature then string fastener 370 elongates to a longer, thinner shape. This process of elongation may be done manually (by hand) or through mechanical equipment. It can also be observed that the manner of welding as mentioned for FIG. 3A may result in a homogeneous material for tag body 304 and string fastener 370 provided that both of these elements are a homogenous material.

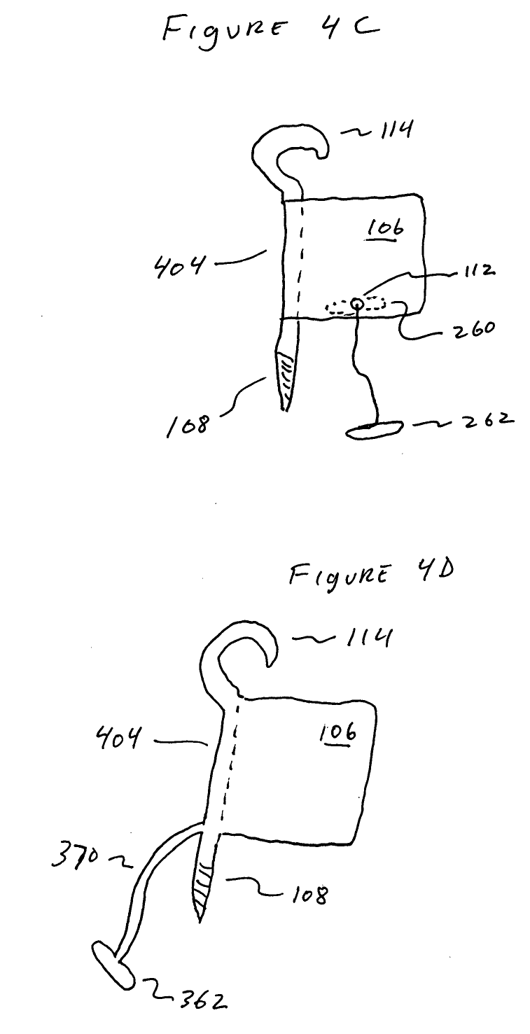

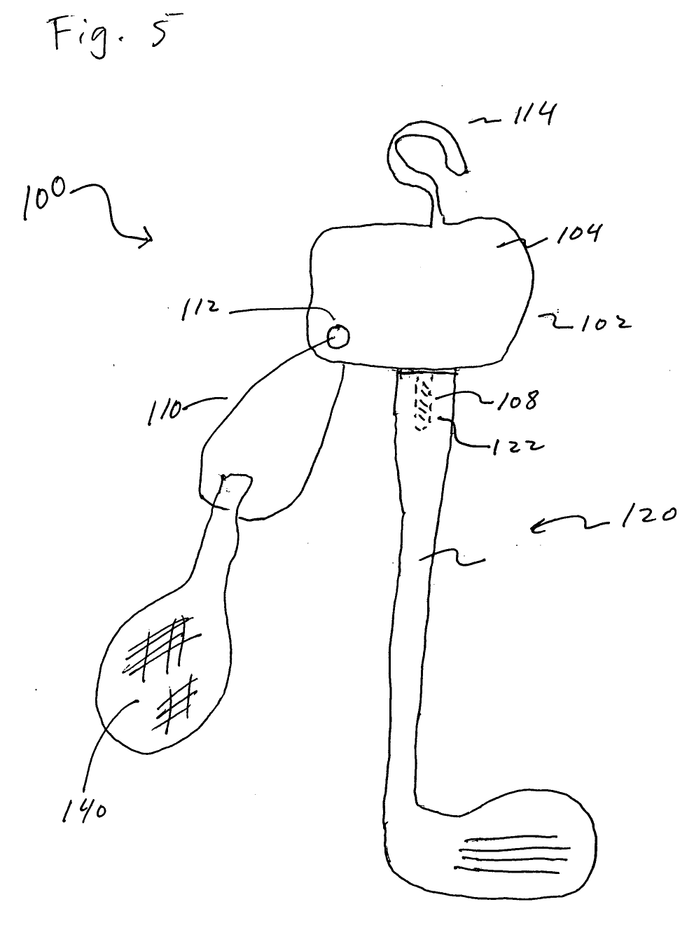

FIGS. 4A, 4B, 4C, and 4D illustrate embodiments of the present invention that utilize a “flag” type design. In this design, tag body 404 has an elongated body. Information housing portion 106 may be an adhesive label that is attached to tag body 404 in the manner of a flag configuration. In this flag configuration, information housing portion 106 is disposed to one side of tag body 404 in the manner of a flag fastened to a mast as is illustrated in FIG. 4B. It should be understood that these same materials could be used to create a “T” type configuration as described for other embodiments—that is, an embodiment having the information portion disposed about both sides of an axis provided by screw fastener 108. It should be noted that in the embodiment of FIG. 4A, string-tag union portion 112 is in the form of an aperture that is molded into the elongated tag body 404.

An alternative embodiment of the flag concept is illustrated in FIG. 4C where information housing portion 106 is fastened to tag body 404 thereby becoming a part of tag body 404. Information housing portion 106 has provided string-tag union portion 112 which in this embodiment is an aperture through information housing portion 106. In this embodiment, a barb-type retainer as is discussed above is provided.

It should also be understood that the “flag” type design can be manufactured as a single homogeneous unit in the same fashion as described for the embodiment of FIG. 3B and such a flag type embodiment is illustrated in FIG. 4D.

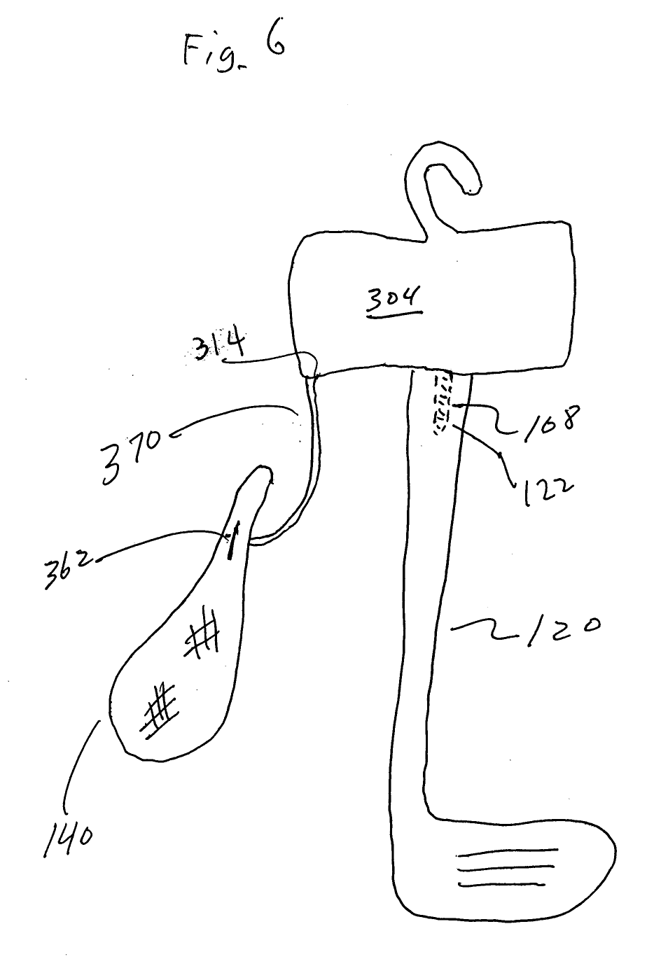

FIG. 5 illustrates one embodiment of the combination 100 of a first article 102, that is, a multi-function tag having a screw fastener 108 and having a loop string fastener 110, with a second article 120, that is, a golf club, along with a third article 140, that is, a golf club head cover.

FIG. 6 illustrates an embodiment of the combination similar to that of FIG. 5 except that the embodiment of FIG. 6 features a string fastener 370 which is integral to tag body 304 and which has a barb 362 at one end of string fastener 370.

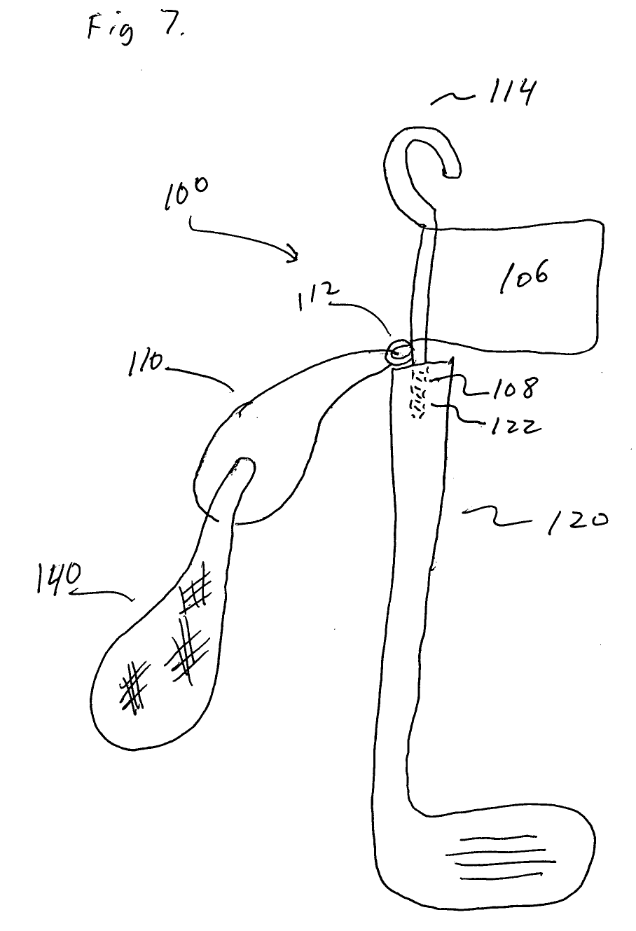

FIG. 7 illustrates a flag-type tag embodiment of combination the present invention employing a flag-type tag as described in connection with FIGS. 4A-4D.

It can be understood that the illustrated embodiments are representative of the present invention as claimed, and that such illustrations are not intended to limit the present invention, but that the present invention is limited by the following claims.

What is claimed is:

1. A combination of articles of manufacture comprising:
a first article comprising a tag, said tag comprising a tag body, an information housing portion attached to said tag body, a male threaded screw fastener attached to said tag body, and a string fastener attached to said tag body;
a second article comprising a screw receiving portion, said second article attached to said tag by a union of said mail threaded screw fastener and said screw receiving portion;
a third article comprising a string fastener receiving portion, said third article attached to said tag by a union of said string fastener and said string fastener receiving portion.

2. The combination of claim 1 wherein said second article comprises a golf club and said third article comprises a head cover for a golf club.

3. The combination of claim 2 wherein said golf club has a grip portion and said screw receiving portion is an aperture in said grip portion.

4. The combination of claim 1 wherein said body has a body aperture, and wherein a portion of said string fastener passes through said body aperture to attach said string fastener to said body.

5. The combination of claim 4 wherein said portion of said string fastener that passes through said body aperture comprises a loop.

6. The combination of claim 4 wherein said string fastener comprises a string fastener barb said string fastener barb that retains an attachment of said string fastener to said body.

7. The combination of claim 1 wherein said string fastener is attached to said tag body by a relatively rigid attachment.

8. The combination of claim 7 wherein said string fastener and said tag body comprise a homogenous material.

9. The combination of claim 7 said string fastener and said tag body are attached by a weld.

10. The combination of claim 1 wherein said information housing portion comprises human readable written information.

11. The combination of claim 1 wherein said information housing portion comprises machine readable information.

12. The combination of claim 1 wherein an adhesive label is attached to said information housing portion.

13. The combination of claim I wherein said information housing portion comprises a substantially planar surface.

14. The combination of claim 12 wherein an adhesive label is attached to said planar surface

15. The combination of claim 12 wherein information is printed onto said planar surface.

16. A combination of articles of manufacture comprising:
a first article comprising a tag, said tag comprising a tag body, an information housing portion attached to said tag body, a frictional fastener attached to said tag body, wherein said frictional fastener has an elongated shape and has ridges disposed substantially perpendicular to a length of said elongated shape, wherein said tag body comprises a body aperture, and wherein said tag comprises a string fastener that passes through said body aperture to form an attachment between said string and said tag;
a second article comprising a frictional fastener receiving portion, said second article attached to said tag by a union of said frictional fastener and said frictional fastener receiving portion and held in place by said ridges; and wherein said second article is a golf club;
a third article comprising a string fastener receiving portion, said third article attached to said tag by a union of said string fastener and said string fastener receiving portion; and wherein said third article is a head cover for a golf club.

17. The combination of claim 16 wherein said frictional fastener comprises a male threaded screw fastener.

18. The combination of claim 17 wherein said frictional fastener receiving portion has an aperture comprising a plurality of ridges.

19. The combination of claim 18 wherein said aperture comprises a female threaded screw receiving portion.

20. The combination of claim 16 wherein said information housing portion comprises an RF tag whereby said RF tag may provide information through a radio frequency medium.
